(19) United States
(12) Patent Application Publication
(10) Pub. No.: US 2002/0116242 A1
(43) Pub. Date: Aug. 22, 2002

(54) Emergency response synchronization matrix

(76) Inventors: James J. Vercellone, Springfield, VA (US); Jacques E. Mitrani, Lemont, IL (US); Paul L. Hewett JR., Bowie, MD (US); Robert J. Sutter, Reston, VA (US)

Correspondence Address: Michael D. Rechtin, Foley & Lardner, Suite 3300, 330 North Wabash Avenue, Chicago, IL, 60611-3608, US

(21) Appl. No.: 09/790,851

(22) Filed: Feb. 22, 2001

(51) Int. Cl. G06F 17/60

(52) U.S. Cl. 705/7

(57) ABSTRACT

A system and method of providing a graphical depiction of an entire emergency response process via a computer generated emergency response synchronization matrix. The matrix provides for real-time adjustments of the complex emergency response system, which can be viewed on a computer screen or in printed form. The matrix also provides for planning in “negative time”, with reference to the time of the emergency incident, effectively controlling the decisions and actions that must be made and taken before the disaster occurs. The synchronization matrix and the method of generating and implementing the matrix are effective tools in optimizing the planning, exercising, and implementation of emergency response plans, taking into account the interaction of a plurality of independent organizations whose actions and decision will effect the actions and decisions of other organizations in the emergency response process.

This invention was made with government support under Contract No. W-31109-ENG-38 awarded to the Department of Energy. The Government has certain rights in this invention.

As part of this specification a microfiche appendix has been prepared with four pages of fiche having a total of 326 frames, including the test target frame.

### BACKGROUND OF THE INVENTION

This invention relates generally to a method for planning and implementing an emergency response to a complex emergency situation. More particularly, this invention relates to a process for planning and implementing an emergency response to a complex disaster that requires the rapid integration, coordination, and synchronization of multiple levels of governmental and non-governmental organizations from numerous jurisdictions into a unified community response.

In 1986, Congress directed the U.S. Army to destroy the nation's stockpile of 30,000 tons of lethal unitary chemical warfare agents and munitions stored at eight locations as part of a chemical stockpile disposal program (CSDP). In 1988, the Department of the Army (DA), with assistance from the Federal Emergency Management Agency (FEMA), established the Chemical Stockpile Emergency Preparedness Program (CSEPP) to provide a consistent framework for emergency planning and management and to enhance existing response capabilities at each storage location and in the adjacent communities.

Consistent with an emergency response to other technical hazards, emergency planning by a CSEPP community involves a variety of governmental and nongovernmental agencies, departments, organizations, and entities from many jurisdictions, both near and distant. For example, the community response at one storage site involves an Indian nation, two states, four counties, and several cities and towns; another community's response consists of one state, ten counties, and numerous cities and towns, not including the federal and national nongovernmental responders to all sites. While each jurisdiction develops its own emergency operations plan and procedures, all jurisdictions are tremendously interdependent during a response. Typically, one jurisdiction's population warning processes and protective actions affect a neighbor's response decisions and, often, a jurisdiction relies on its neighbors to take actions to support its response and shelter its citizens. Response plans at the eight CSEPP locations fill many loose-leaf binders as they attempt to capture the complex relationships and interactions required to protect the public from harm.

Emergency planning by state and local government emergency management agencies typically results in lengthy, multi-chapter emergency operations plans and standard operating procedures that are updated infrequently. FEMA recommends that such plans contain eight annexes for “core” response functions and up to an additional eight annexes for specific hazards. While emergency management agencies develop response plans and procedures for an array of hazards within their jurisdictions on the basis of their own unique needs and considerations, plan development seldom includes interjurisdictional coordination. Generally, the plans and procedures take into account the potential needs of the general public, special populations (such as prisons and hospitals) and individuals (a public transportation dependent senior, for example), and responders, as well as resources and capabilities over which the agencies have direction and control. Reflecting the hazards and available protective actions they address, these response plans can become quite complex with their differing procedures and approaches to each hazard, accident, or disaster. When faced with a fast-paced, terrifying disaster, as can be expected in the unlikely event of an accident at a chemical weapons storage facility, well-developed predisaster planning and the coordination of responder actions at all levels and within and between affected jurisdictions are imperative. However, these plans often fail to take on a community perspective of the response process.

A common thread in responding to a disaster is the enormity of the consequence, the involvement of multiple levels of governmental and nongovernmental organizations from numerous jurisdictions, and the rapid and close coordination necessary to respond effectively. As early as 1969, more than sixty discrete units of government ranging from volunteer fire departments to the Executive Office of the President are reported to have responded to a single incident in Topeka, Kans. Researchers have indicated that a response to even a “minor disaster” requires the involvement of 10 to 80 governmental and nongovernmental organizations. Other reports have disclosed the surprise of local emergency personnel at the number and diversity of responders from both within and outside the community which converge on the disaster site.

Researchers also agree that a successful response involves coordination and communication both in predisaster planning and during the response. One researcher stated that emergency management can be considered successful if there has been the development of interorganizational coordination. Others similarly stress that the success of disaster response operations is substantially affected by the achievement of effective interorganizational coordination among responding groups and organizations. After examining recent disaster experiences, others recognize that same central theme—a need for all levels of government to develop a cooperative plan for and response to emergencies. Following a proliferation of major incidents and crises in the United Kingdom, the government enacted civil protection measures to create an integrated emergency management policy in which the main role of local authorities is identified as developing “an integrated approach to emergency management.

Response to a disaster without such coordination will most likely stress and overextend the limited and dispersed individual emergency response organizational capabilities and resources. And, according to one researcher, unless the inherent governmental distances caused by differing procedures and approaches among organizations in different functional areas at various levels of government are addressed in advance of a response, a communications disaster will occur as well. For example, in describing a hypothetical sarin disaster, one researcher has noted the fact that the disaster plan of each governmental department was never coordinated and integrated with each other, nor tested as such.

Detailed coordination within and among responding organizations increases the length and complexity of response plans, which poses a significant response problem. For example, the CSEPP Annex and associated operating procedures found in one county's emergency operations plan (EOP) exceeds 230 pages as it identifies numerous interactions between both its internal responders and other responding jurisdictions. The underlying EOP for that country is even longer. This is typical of plans and hazard-specific annexes found across the country in jurisdictions-participating in the CSEPP or in FEMA's Radiological Emergency Preparedness (REP) program. Some have found that these large and detailed plans tend to be ignored by those charged with implementing them. Others suggest that some of the best preparedness planning exists in organizations and communities which do not have much in the way of written plans.

Human factors studies tell us that as complexity and volume increase demand on the human brain, the entire problem—in this case, the planned response to a disaster—can no longer be adequately managed in active memory. A person's cognitive and perceptual resources are typically limited in the sense that each can normally be used for only one task at a time. Therefore, as the complexity of emergency response planning increases because of an expanding level of inter-jurisdictional and organizational interaction, the more difficult it becomes for a person to understand the complete plan and manage the overall response. It is known that if a disaster plan is to work when needed, both its content and its intent must be conveyed to those who will be involved in the response. Researches have further indicated that members of responding organizations must know not only what to do, but also what role their organization is seen as playing in the larger response. While most governmental and nongovernmental organization emergency response directors have an overall sense of their response plan and procedures, the actual implementation details can be overwhelming. In addition, many responders and staff are volunteers and must refresh their understanding of the emergency plan and procedures by reading them while engaged in the response.

Existing research seems to indicate that, even with a moderately complex plan, a concise method of portraying its details is required to reduce the recall process and to support the mental analysis needed to implement the interactions and resolve inconsistent interrelationships. At least one researcher calls for systems approach to planning that takes in a community perspective. A problem solving model for emergency planning is recommended by others. In industry, project managers use graphic summaries, such as program evaluation review technique (PERT) diagrams and Gantt charts, to resolve this problem for long-term, complex projects. However, such systems have not been successfully used in the dynamic environment of response management because of their inability to easily integrate dissimilar plans. Some feel that “military” planning models, specifically, the command and control model, are bad analogies for disaster planning. However, others suggests that the military's distinction between strategy and tactics might be followed and that planners use an overall strategic approach to plan for and solve the general problems associated with disasters.

Emergency planners are faced with a dilemma. How do they develop a plan that is “just right” in the amount of detail, is not so large that it is actually read and used, takes a systems approach, and integrates and coordinates the responding agencies?

In the late 1980s, the U.S. Army was faced with a problem of operational complexity similar to that of emergency planners as it implemented its Air-Land Battle strategic concept. This strategic concept required the integration, coordination, and synchronization of military unit actions over a large geographic area. To be able to integrate and synchronize combat operations, the Army examined the battlefield and performed two tasks: (1) broke combat operations into functional operating systems, calling them Battlefield Operating Systems (BOS), and (2) it organized the battlefield and support areas to reflect the space in which they were occurring, by identifying deep, close, and rear components. Linking these operational elements with time and expected enemy actions set the framework for the Army's solution to the complexity problem, the creation of a synchronization matrix. The development of a synchronization matrix is now part of the Army's decision making process performed prior to writing an operations plan.

In an effort to provide a solution for emergency planners and responders in integrating, coordinating, and synchronizing their emergency plans and procedures, Argonne National Laboratory (ANL) developed a response management tool based on the Army's proven synchronization matrix and decision making process. An emergency response synchronization matrix (ERSM) was constructed along similar lines to organize the increasingly complex interjurisdictional response necessary to meet CSEPP response requirements. In adapting the Army's concept, ANL had to identify a set of functional operating systems used in emergency response and determine and allocate the spatial configuration of a response. ANL then had to assess whether an ERSM could accurately and easily depict the complex flow and multiple interdependent actions within and among jurisdictions and various levels of governmental and nongovernmental organizations during a response. Finally, the Army's synchronization matrices are prepared for each phase of an operation as it is actively occurring, usually using “pencil and paper.” To complete the adaptation, ANL has developed software that allows emergency managers to develop, store, and later revise an ERSM as part of their continuous planning process.

### SUMMARY OF THE INVENTION

It is therefore an object of the invention to provide an improved system for displaying a detailed emergency response process involving several distinct organizations.

It is a further object of this invention to provide a novel system for depicting a complex emergency response process involving interrelated actions and decision events to be performed by a plurality of independent organizations.

It is yet another object of this invention to provide an improved system for displaying a detailed emergency response process wherein a plurality of decision events and completed and incomplete actions are displayed for a plurality of users.

It is still another object to this invention to provide an improved system for displaying an emergency response process wherein a plurality of users can input information regarding the process from a plurality of remote locations.

These and other objects, advantages and features of the invention together with the organization and manner of operation thereof will become apparent from the following detailed description when taken into conjunction with the accompanying drawings wherein like elements have like numerals throughout the drawings described below.

In accordance with the above objects, this invention provides for a system and method of providing a graphical depiction of an entire emergency response process via a computer generated emergency response synchronization matrix. The matrix provides for real-time adjustments of the complex emergency response system, which can be viewed on a computer screen or in printed form. The matrix also provides for planning in “negative time”, with reference to the time of the emergency incident, effectively controlling the decisions and actions that must be made and taken before the disaster occurs. The synchronization matrix and the method of generating and implementing the matrix are effective tools in optimizing the planning, exercising, and implementation of emergency response plans. A software program used during the development of emergency plans and procedures from the initial formulation of concept operations, to response visualization, reduction of concepts to written plans and procedures, integration and synchronization of plans and procedures, execution of the plans and procedures, analysis of the effectiveness of the actual response and assessment of current plans and procedures in view of this analysis, and the improvement of the current plans and procedures. This system-based approach to emergency planning depicts how a community organizes its response tasks across space and time in relation to hazard actions. It provides the opportunity to make real-time adjustments as necessary for maximizing limited resources in protecting area residents.

### BRIEF DESCRIPTION OF THE DRAWINGS

FIG. 1 is a table showing a comparison of emergency response functions;

FIG. 2 is a table describing sample operating systems to be used in an ERSM and the associated functions of each operating system;

FIG. 3 is a representation showing a response area organization for a sample chemical stockpile emergency;

FIG. 4 is a chart showing the general layout for a synchronization matrix;

FIG. 5 is a chart showing a sample response flow for an ERSM;

FIG. 6 is a chart showing a detailed ERSM according to the present invention;

FIG. 7 is a chart showing another detailed ERSM according to the present invention; and

FIG. 8 is a box diagram showing an ERSM according to the present invention.

### DETAILED DESCRIPTION OF THE INVENTION

In order to illustrate embodiments of the invention, an explanation is provided to describe the methodology and function of an emergency response synchronization matrix in accordance with the general concept of the present invention. Although the manner in which the phenomena is described is one rigorous approach which explains the operation of the invention for those skilled in the art, other conventional mathematical and theoretical explanations can also be used to describe similar results which characterize embodiments of the invention. The invention is therefore not limited to the description of its operation by the following explanations.

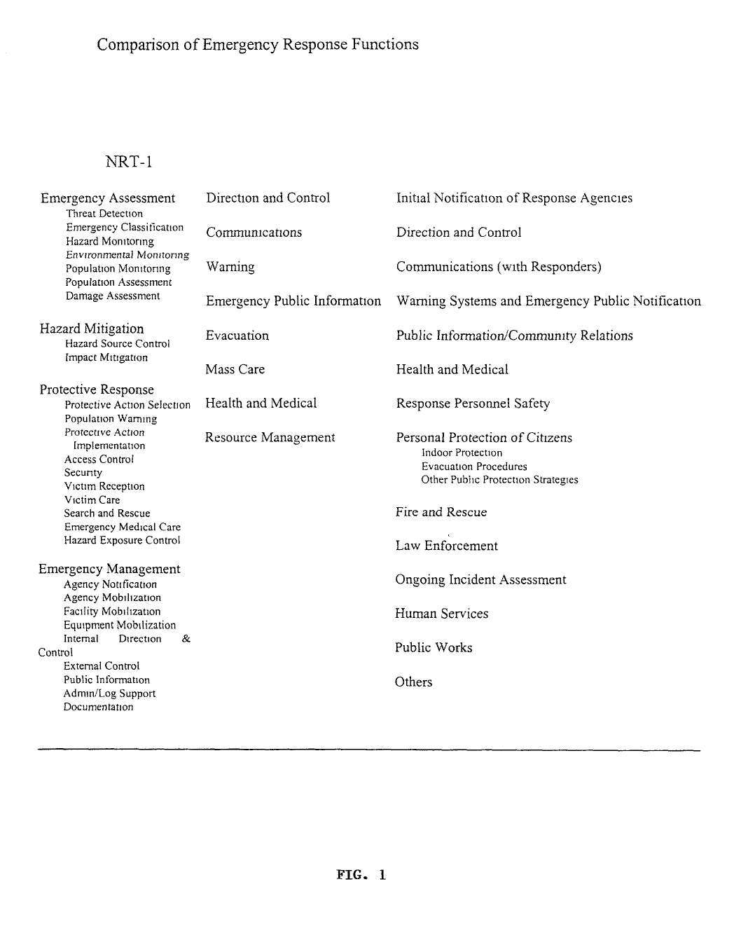

To take the systems approach to planning recommended by one researcher, the systems first have to be identified. Several sources offer insights into possible functional operating systems for emergency response. For example, some researchers identify four generic emergency response functions and associated “specific actions” that apply to a broad range of emergencies. FEMA's State and Local Guide characterizes emergency response with eight “critical emergency functions that the jurisdiction will perform in response to an emergency.” Fourteen response functions are identified in the National Response Team's Hazardous Materials Emergency Planning Guide. Each of these sources presents a task-oriented approach to response planning. FIG. 1 gives a comparison of the emergency response functions of these three sources.

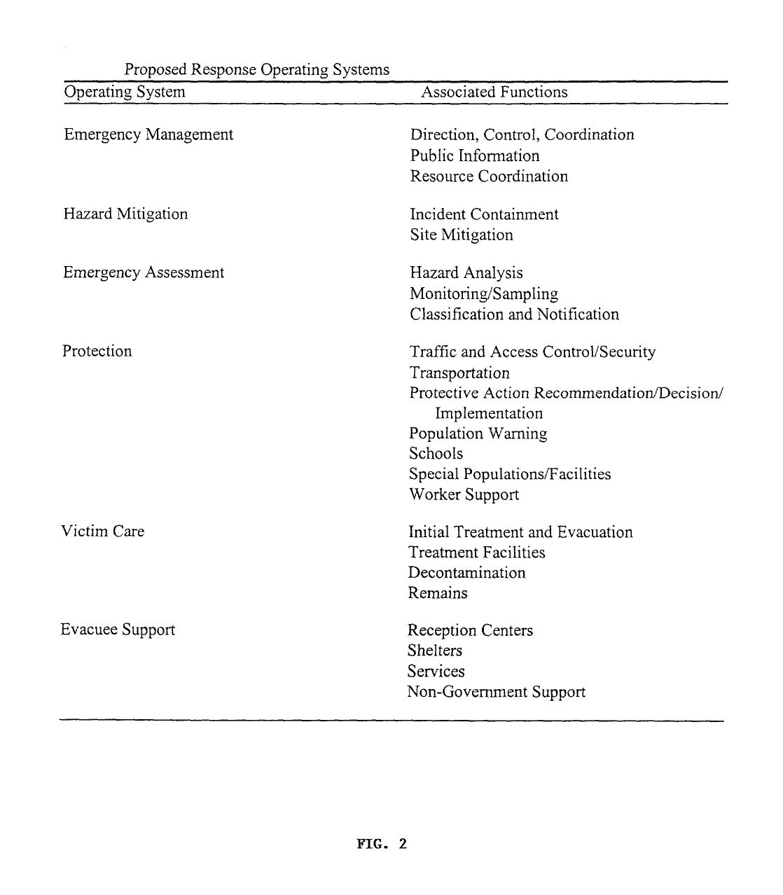

Building on two decades of experience evaluating both response plans and operations during annual REP and CSEPP exercises at facilities across the United States, ANL has refined these functional patterns into six response operating systems (ROS). For the ERSM, a ROS is defined as those critical major functions performed by governmental and nongovernmental organizations to respond successfully to a disaster and to protect the public. Each ROS was further subdivided to identify a set of supporting task groups. Under this concept, the task groups are the “functions” that occur in a ROS. FIG. 2 presents the ERSM ROS and the underlying response functions associated with each system. Communications is not identified as a separate operating system or function, as it occurs across the entire response.

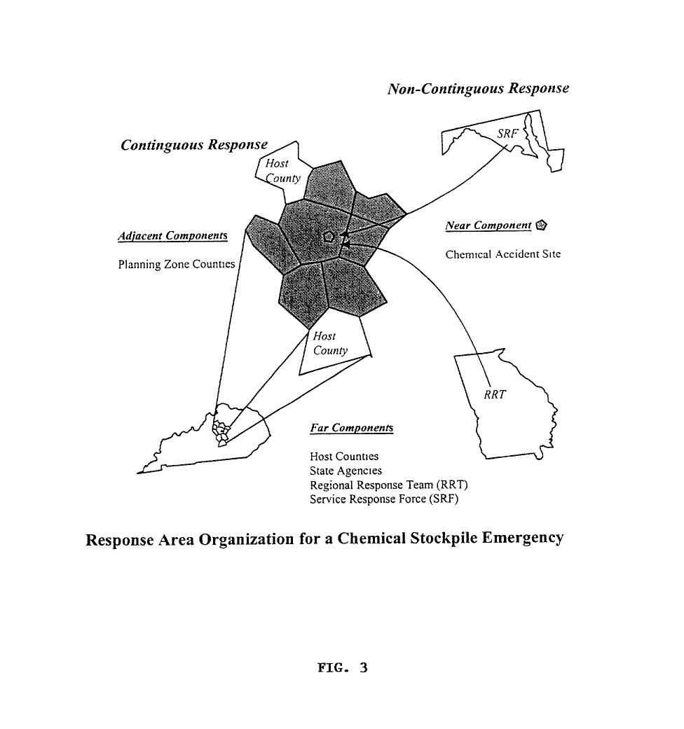

Disaster response space is that area in which emergency managers conduct response operations. Response space can be separated into three distinct locations: near, adjacent, and far. The affected space can expand or contract over time on the basis of the nature and threat of the hazard, the number and variety of responding agencies, and mitigation rendered. FIG. 3 depicts the organization of the disaster response space for an incident at a chemical warfare agent stockpile.

The near component of the response area is delineated as the actual accident/emergency/incident site. Examples of near component areas include the proximate scene where a chemical agent incident occurred, or the belt or swath damaged by a tornado. In the near area, responder involvement is immediate, that is, starting in less than 15 minutes after the incident. For a chemical weapons stockpile site, government or government-contracted first responders and incident commanders have total responsibility for the response in this near component.

The adjacent component includes the area immediately surrounding the disaster scene that has been directly affected. In a hazardous materials incident, the adjacent component would consist of downwind areas containing a population, facilities, or infrastructure to be protected from the effects of a release. For a natural disaster, the adjacent component would be that portion of a host jurisdiction or an undamaged contiguous jurisdiction where resources can be rapidly mobilized to support response in the near component. Another example of an adjacent component is the set of emergency planning zones associated with the CSEPP or REP. While response in the near component may be the responsibility of a private concern (e.g., a chemical manufacturing plant's internal HAZMAT team) or public unit (e.g., fire department or HAZMAT team), response in the adjacent component is typically the responsibility of municipal or county governments. In general, responders are deployed in the adjacent component anywhere from thirty minutes to two hours after the incident.

The far component includes areas situated outside the spatial boundaries of the near or adjacent components; they are not always contiguous to the other two components. These locations are where governmental and non-governmental organizations direct or coordinate their responses or stage their support activities. These locations “contain” state agency and department, federal government, and non-governmental organization response elements. For example, federal agencies providing response assistance may coordinate operations from regional response centers or stage equipment and personnel at locations hundreds of miles from the incident site. Typically, the direct involvement of those located in the far component is greatly delayed, usually taking more than two hours to deploy. These organizations require time to activate and mobilize before they can be integrated into the response.

Though they may be conducted or controlled by a variety of organizations, the response activities that occur in each of these three spatial components are not separate or detached. The actions of responders in the near component must be closely coordinated, integrated, and synchronized with those occurring simultaneously in the adjacent and far components. Likewise, the actions in the far component must occur at the appropriate time so that suitable and sufficient resources can be injected into the response activity at the correct time and place to optimize public protection efforts and the mitigation or amelioration of the effects of the accident.

### The Emergency Response Synchronization Matrix

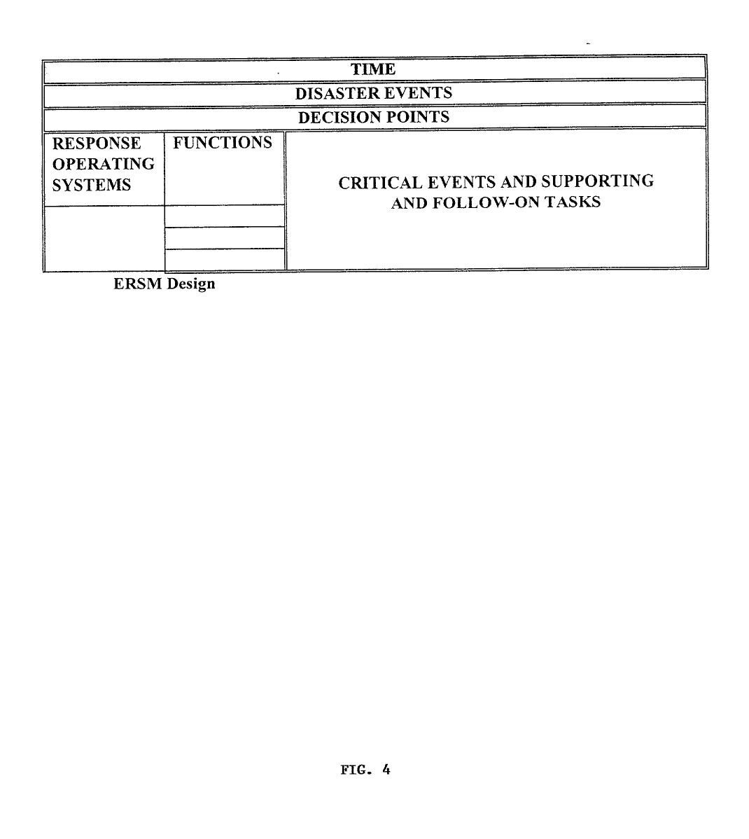

The ERSM is a systems-based graphical portrayal of a response. The ERSM depicts the response plan and how response tasks are synchronized across jurisdictions and organizations and time in relation to a disaster scenario. The matrix has been designed with the ROS and associated functions listed on the left side (vertical axis); the disaster time line, decision points, and tasks associated with the ROS are portrayed on the top (horizontal axis). FIG. 4 depicts the layout that ANL has developed for the ERSM.

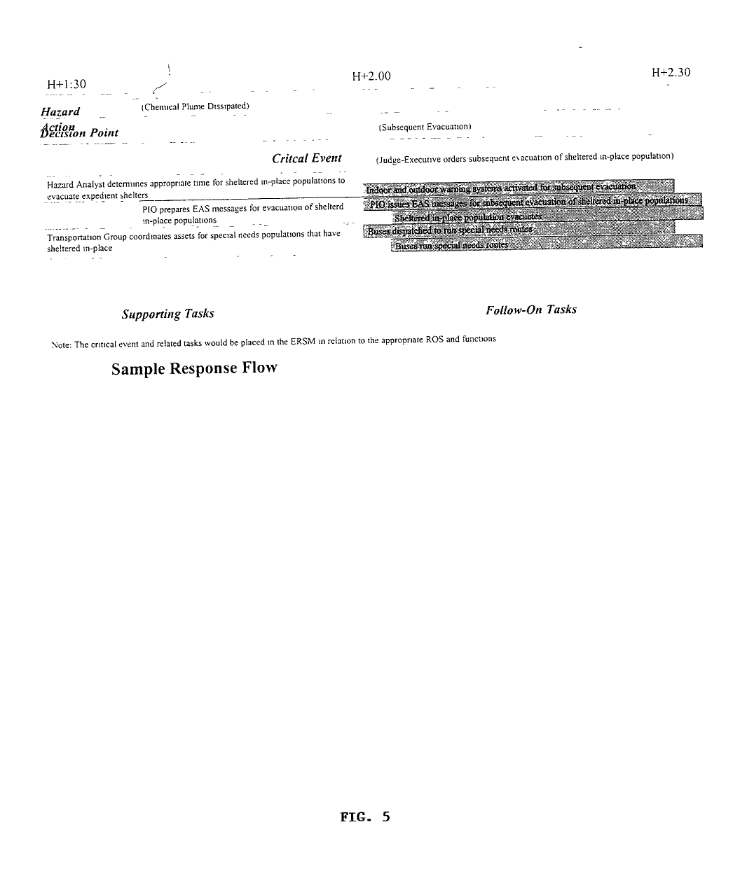

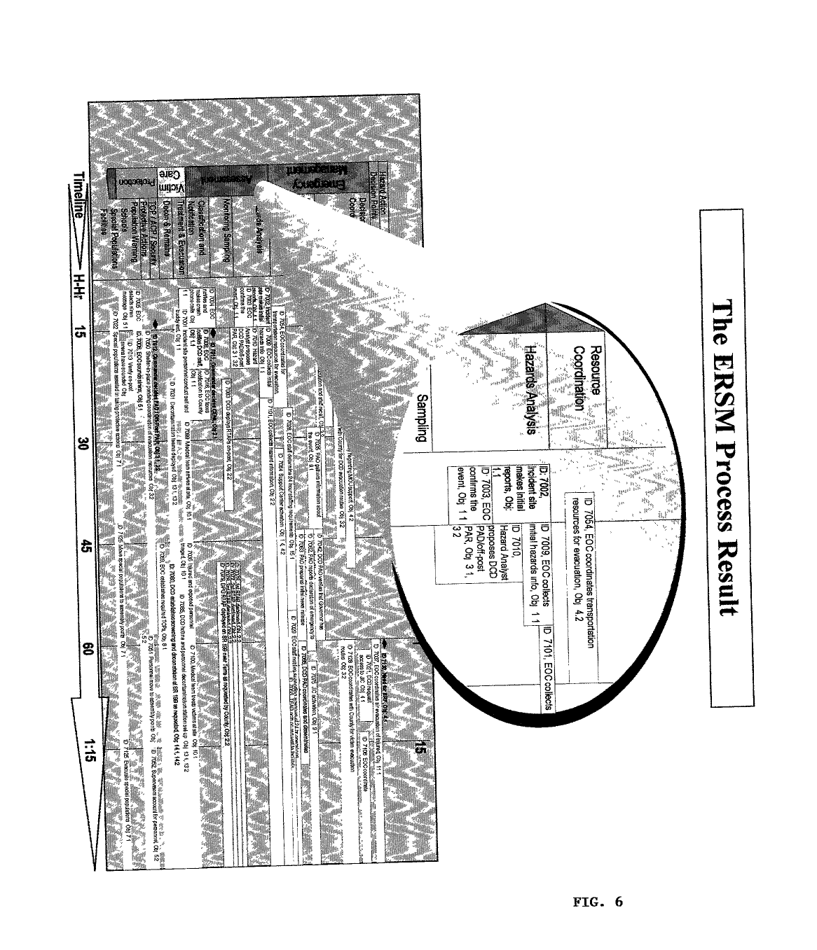

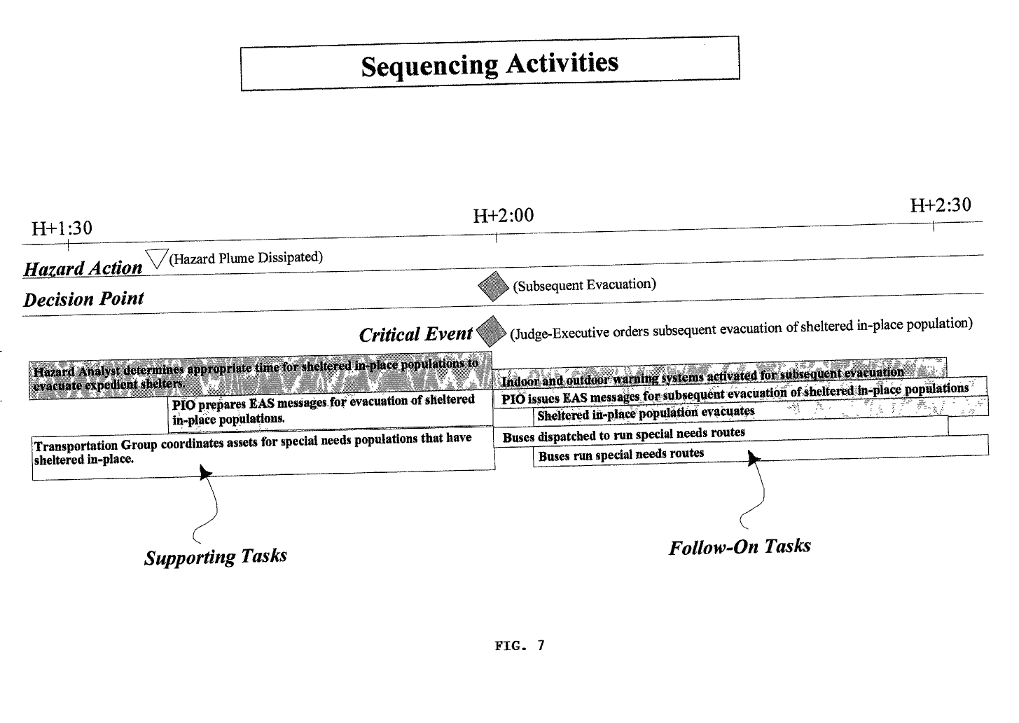

An ERSM for a specific site is constructed using a series of five steps. The first step is to establish a prescribed time line or a set of predetermined phases of a response. Time entries are based on set intervals (i.e., hours/minutes, days/hours, etc.) before or after a disaster occurs. Phases are defined as broad process intervals, such as the phases of emergency response (i.e., preparedness, response, recovery, mitigation). Time line intervals are determined by the nature and potential threat of the hazard. For example, the interval for a chemical warfare agent accident may be minutes and hours, while the interval for a hurricane during the preparedness phase (tracking the hurricane) may be hours and days. The second step is to record when significant disaster events would occur, such as a chemical plume tip reaching a discrete receptor. These data provide the assumptions about the hazard upon which the response actions are based. Next, decision points for response actions are entered. Each decision point shows when emergency managers must make a decision, typically about a critical event, to have an optimal effect on achieving the desired response end-state. Decision points do not dictate what the decisions are, only that they should be made. The fourth step is to indicate critical events. A critical event is an activity that directly influences the responses and actions. Critical events may trigger a sequence of follow-on diverse, single responses and actions; may be a set of complicated actions (such as making all traffic on an Interstate highway flow in one direction); or may be a set of essential tasks (such as the process of opening shelters after an evacuation is ordered). The fifth step is to enter all of the supporting or follow-on response tasks and activities. Both critical events and supporting tasks and activities are entered into the ERSM in relationship to the ROS, disaster time line, and decision points. FIG. 5 is an example of a response action flow. FIGS. 6 and 7 show detailed partial emergency response synchronization matrices, with each matrix showing the coordination of multiple organizations in response to a disaster event.

### The ERSM as a Planning Tool

When the ERSM is used as a planning tool, three types of matrices are prepared: a concept of operations matrix, a jurisdictional matrix, and a community matrix. The concept of operations matrix is prepared first. It depicts the entire response scheme in a general manner for a particular hazard and is prepared by lead planners of the affected jurisdictions. For example, lead planners from affected states, counties, and a large hazardous materials storage site would collectively prepare a concept of operations matrix depicting the general response tasks to be carried out by the storage site (near component), the counties (adjacent component), and the states' agencies and departments (far component) in the event of a catastrophic accident at the specified storage site. The concept of operations matrix is provided to all of the jurisdictions involved in the disaster response. Each jurisdiction then, prepares a detailed jurisdictional matrix for the portion(s) of the general response that they are responsible for executing. Once these jurisdictional matrices have been prepared, the respective jurisdictions would resource-load the tasks and write draft response plans. Last, a community response matrix is prepared by rolling up the individual jurisdictional matrices. The jurisdictions then meet and review the overarching community matrix, to ensure that interjurisdictional tasks have been coordinated and that any gaps have been filled. Jurisdictional matrices, and, if appropriate, the concept of operations matrix, are adjusted to reflect the results of the community matrix review. Draft response plans are also revised and a final version is prepared.

During concept pilots conducted in 1998 and 1999 in the state of Utah, ANL was able to show that this planning process can be reversed and that an ERSM can be developed from existing response planning information. First, the jurisdictional matrices are constructed using data collected from emergency plans, mutual aid agreements, standard operating procedures, implementing procedures, checklists, and interviews. Once constructed, the jurisdictional matrices are rolled up into a community matrix to match timing and jurisdictional interactions. Lead planners then meet and look for gaps and discrepancies among the individual and collective planned responses of each jurisdiction in the overarching community matrix. Once the jurisdictional matrices have been reviewed and modified, detailed tasks are consolidated and the general concept of operations matrix is prepared. Individual emergency operations plans are subsequently revised, as needed. Thus, this process can be used to improve existing emergency plans.

### The ERSM as a Tool for Exercise Design, Control, Analysis, and Reporting

Evaluation of emergency operations plans is an essential aspect of the planning and preparedness process. The graphic depiction of the entire response process provided by an ERSM offers many advantages to an exercise and evaluation team.

Design.

Exercise designers can use an ERSM as a tool to fashion a robust simulated event environment that allows for realistic participant response, with scenario progression based on participant actions and decisions. The exercise scenario is “overlaid” on the ERSM, and the disaster event time line assumed for planning purposes can be adjusted to that of the exercise scenario. Using the synchronization matrix and negotiated extent-of-play agreements as a guide, expected player responses are “war-gamed” and appropriate implementers are written to reflect war-gaming scenarios. For example, if a jurisdiction's operations plan directs the dispatch (the task) of five traffic control points (TCPs) and only two are to be demonstrated (extent-of-play), then the arrival of law enforcement units and other designated support personnel at the three non-demonstrated TCPs would be simulated through suitably timed implementers to the appropriate player(s). Likewise, if one or more of the planned TCPs is war-gamed to be delayed in its activation because of problems with traffic congestion caused by an evacuation, this prescripted information would be indicated through implementers to the appropriate player(s). Prescripted implementers can be developed for a decision's options (for example, the set of four possible protective actions) and the resulting follow-on actions (subsequent operations based on the outcome of the decision). These implementers are tied directly to response actions on a jurisdiction's synchronization matrix.

Control.

As a control document, the ERSM provides the capability to ensure that implementers are injected at the appropriate time on the basis of real-time player actions and not at artificially estimated times. Because implementers are tied directly to response actions on a jurisdiction's synchronization matrix during exercise design, exercise controllers have a ready guide to indicate when implementers should be injected into play. Controllers direct implementation of injects on the basis of when player actions occur. As an exercise unfolds, early or delayed actions are reported from field controllers over a separate controller communications network. These actions are also tracked by other controllers, located in an exercise control cell, who use the ERSM as a reference. The exercise lead controller then ensures that the exercise control staff and field controllers adjust the timing for injecting implementers to match the speed of play in the exercise.

Analysis.

When using an ERSM, determining exercise results is a two-step process: (1) collection of data in the form of evaluator observations and, (2) analysis team examination of the data in the context of the hazard scenario. The ERSM is the tool that links these two actions.

Data Collection.

Even skilled evaluators cannot observe every action of every individual, team, section, or organization involved in a response. Evaluators must focus their observations on the critical response actions required to achieve the response goal. To do this effectively, they must identify the key events and then position themselves in the right place at the right time to observe participant actions. By indicating these critical tasks, the ERSM serves as a positioning guide for the evaluation team, thus contributing to optimal data collection. Evaluators also are able to make notes on the ERSM to aid in their assessment of the exercise. Typical annotations would include the exercise start time, the actual time a task is started or completed, whether a task actually is accomplished, and any new or different consequential actions.

Data Examination.

Using a process similar to that when initially constructing an ERSM, analysts are able to use the ERSM to organize their assessment of the response and to formulate a picture of what happened at their locations during the exercise. Evaluation team leaders can walk evaluators through the exercise play, to ensure that all functions, organizations, and operating systems have been addressed and that actions have been examined in context (What was supposed to occur? What actually occurred? Why was there a difference?). During this process, the evaluation team identifies actions and issues that may have been influenced by the actions, inaction, and decisions of other jurisdictions. It then seeks input from evaluation teams for other jurisdictions for additional perspective on these interjurisdictional relationships. This, in turn, leads to consequence analysis and answering the question: “Did the actions achieve the desired end-state for the response?”

Reporting.

The ERSM can be used in two ways to report exercise results. First, it can be used in a manner similar to that for results analysis to provide an after-exercise review to a jurisdiction. Employing each jurisdiction's synchronization matrix, the exercise leader has a graphical aid for presenting a picture of each jurisdiction's own response. On the basis of the analysis, the evaluation team leader can show exercise participants the flow of the response and what worked where, explain the effects of early or delayed action, identify gaps in plans or procedures, and provide a consequence analysis. Second, as an addendum to the written report, the ERSM gives each jurisdiction a tool from which to develop changes to plans and procedures.

### The ERSM in Emergency Response Operations

Two of the three ERSM matrices can be used as aids in coordinating, integrating, and synchronizing the disaster response in real-time. The general concept of operation matrix enables all jurisdictions to see how they fit into the overarching response as it progresses. The jurisdictional matrix enables them to determine how their respective departments and agencies are progressing in meeting the jurisdiction's responsibilities in the specific disaster response being orchestrated. If an action occurs early or late, or not at all, a jurisdiction is then able to see whether that action affects not only its portion of the response, but the overall concept of operations. Appropriate adjustments to the disaster response can then be made both within each jurisdiction and across all jurisdictions.

Individuals from many jurisdictions and levels of government are relied on to effectively and efficiently respond in a timely manner. The ERSM enables these individuals and their organizations to assess quickly where they fit into the ongoing operation and to understand the progression of the response. It also facilitates rapid assimilation of response “outsiders” into a community's response efforts.

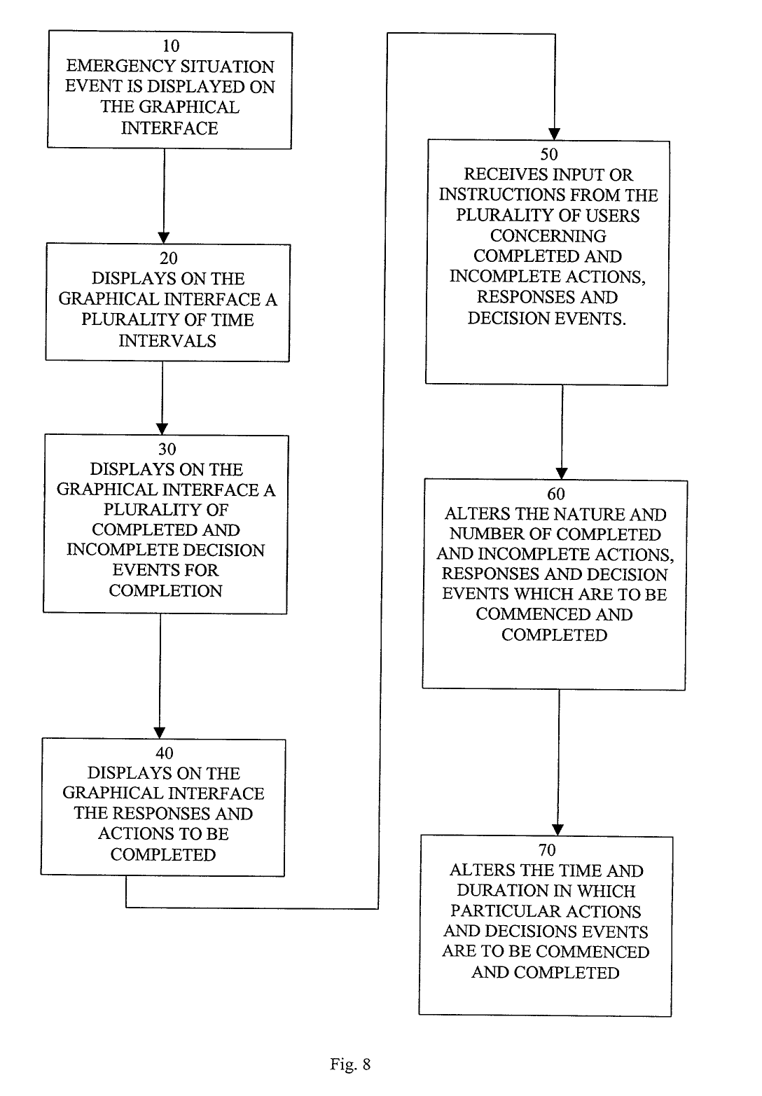

FIG. 8 is a box diagram showing an ERSM according to the present invention. The box diagram is in the form for method for implementing an emergency response to a multiple-variable emergency situation. For this method, an automated system is used to provide the graphical interface for displaying and processing information.

In step 10 of the method, an emergency situation event is displayed on the graphical interface using the automated system. As indicated, the emergency situation event may result from an array of hazards, accidents or disasters, such as an accident at a chemical storage facility. In step 20, the automated system displays on the graphical interface a plurality of time intervals for the emergency situation event. Each time interval represents a particular phase of the emergency response. Following this is step 30. In this step, the automated system displays on the graphical interface a plurality of completed and incomplete decision events for completion by one or more of the plurality of users. The plurality of users may be a plurality of government organizations. The decision events may be based on critical or non-critical decisions that need to be made by one of the users.

In step 40, the automated system displays on the graphical interface the responses and actions to be completed by one or more users. The responses and actions represent one or more time intervals such that the nature, time, level of completion and duration of the responses and actions can be determined. Proceeding to step 50, the automated system receives input or instructions from the plurality of users concerning completed and incomplete actions, responses and decision events. These instructions can be received from a plurality of locations both local and remote.

In response to step 50, the automated system in step 60 alters the nature and number of completed and incomplete actions, responses and decision events which are to be commenced and completed depending upon the instructions received from one of the plurality of users concerning actions and decisions events. In step 70, the automated system also alters the time and duration in which particular actions and decisions events are to be commenced and completed depending upon the instructions received from one of the plurality of users concerning actions and decision events.

### Conclusions

While a decade of research has stressed the importance of coordination and cooperation during a response, most jurisdictions practice self-reliance and self-sufficiency in emergency response planning. As the type and magnitude of potential disasters currently faced by communities has been expanded to include significant chemical, biological, and technological terrorist actions, an even greater need exists for an increased level of coordination and cooperation among all levels of jurisdictions. In this new, more complex response environment, the multi-chaptered emergency operations plan is not an adequate tool for responders, because it is often too complex for responders to implement effectively. Emergency planning must follow a new paradigm and draw heavily on the recently proven Army Air-Land Battle concept that relied on the integration, coordination, and synchronization of military unit actions over a large geographic area. The ERSM is an adaptation of this concept and provides an all-hazards tool that allows any individual or organization responsible for planning, evaluating, or conducting an emergency response to do so in a coordinated, integrated, and synchronized manner.

While preferred embodiments have been shown and described, it should be understood that changes and modifications can be made therein without departing from the invention in its broader aspects. For example, it is possible that a variety of computer programs could be utilized in the development, use and maintenance of an ERSM by those of ordinary skill in the art while not subtracting from the functionality of the invention. Additionally, an ERSM can be used for many different types of emergency situations, including but not limited to tornadoes, hurricanes, fires, earthquakes, floods, acts of God, riots, explosions, chemical and nuclear releases, and other natural and man-made disasters. Various features of the invention are defined in the following claims.

What is claimed is:

1. A method for coordinating a plurality of emergency responses to a multivariable emergency situation, comprising the steps of:
using an automated system to display the duration, time, and nature of a plurality of complete or incomplete actions and decision events to be performed by a plurality of users;
using an automated system to receive instructions from the plurality of users concerning the actions and decision events; and
using an automated system to alter the time, duration, number, level of completion and nature of a plurality of decision events and actions depending upon the instructions received from the plurality of users regarding a single action or decision event.

2. The method of claim 1, wherein the actions and decision events are displayed on at least one graphical interface.

3. The method of claim 2, wherein the plurality of users are capable of transmitting instructions to the automated system from a variety of remote locations.

4. The method of claim 3, wherein the plurality of users comprise a plurality of government organizations responsible for particular actions or decision events.

5. A method for implementing a plurality of emergency responses to a multiple-variable emergency situation, comprising the steps of:
using an automated system to provide a graphical interface for displaying an emergency situation event;
using an automated system to display on the graphical interface the duration, time and nature of a plurality of completed and incomplete actions performed by a plurality of users, the actions representing a plurality of emergency responses to the emergency situation;
using an automated system to display on the graphical interface a plurality of completed and incomplete decision events for completion by one or more of the plurality of users, each decision event representing a decision to be made in response to the emergency situation;
using an automated system to receive instructions from the plurality of users concerning completed and incomplete actions and decision events;
using an automated system to alter the nature and number of completed and incomplete actions and decision events which are to be commenced and completed depending upon the instructions received from one of the plurality of users concerning actions and decision events; and
using an automated system to alter the time and duration in which particular actions and decision events are to be commenced and completed depending upon the instructions received from one of the plurality of users concerning actions and decision events.

6. The method of claim 5, wherein each completed or incomplete action is designated for one of the plurality of users, wherein only the one of the plurality of users is capable of manipulating the action.

7. The method of claim 6, wherein each completed or incomplete decision event is designated for one of the plurality of users, wherein only the one of the plurality of users is capable of manipulating the decision event.

8. The method of claim 7, wherein the graphical interface can be adjusted by the one of the plurality of users to display only those decision events and actions that are designated for the one of the plurality of users.

9. The method of claim 7, wherein instructions regarding actions and decision events can be received from a plurality of remote locations.

10. The method of claim 9, wherein the plurality of users comprise a plurality of government organizations responsible for particular actions or decision events.

11. An emergency situation management network, comprising:
a graphical interface for displaying an emergency situation event, the nature, duration and time of a plurality of completed and incomplete actions performed by a plurality of users and the nature and time of a plurality of decision events upon which a decision is to be made by one of the plurality of users, the actions and decision events representing a plurality of responses to an emergency situation;
a memory for storing the nature, duration and time of the actions and the nature and time of the decision events;
means for permitting the plurality of users to input instructions concerning the completion of actions and decisions made in response to a decision event; and
a processor for altering the number, time, duration, and nature of actions and decision events in response to instructions input by the plurality of users.

12. The emergency management network of claim 11, wherein the graphical interface may be accessed by the plurality of users from a plurality of remote locations.

13. The emergency management network of claim 12, wherein instructions can be input by the plurality of users from a plurality of remote locations.

14. The emergency management network of claim 13, further comprising means for designating particular actions or decision events as to be completed by one of the plurality of users.

15. The emergency management network of claim 14, wherein one of the plurality of users may only input instructions concerning actions or decision events that are designated for the one of the plurality of users.

16. The emergency management network of claim 15, wherein the graphical interface is capable of displaying actions and decision events that are designated for only one of the plurality of users.

17. The emergency management network of claim 16, wherein each of the plurality of users comprises a government organization responsible for particular actions or decision events.

18. A method for implementing an emergency response to a multiple-variable emergency situation, comprising the steps of:
using an automated system to provide a graphical interface for displaying an emergency situation event;
using an automated system to display on the graphical interface a plurality of time intervals, each time interval representing particular phase of the emergency response;
using an automated system to display on the graphical interface a plurality of completed and incomplete decision events for completion by one or more of a plurality of users, each decision event representing a decision to be made in response to the emergency situation;
using an automated system to display on the graphical interface the responses and actions to be completed by one or more users, the responses and actions being represented in one or more time intervals such that the nature, time, level of completion, and duration of the responses and actions can be determined;
using an automated system to receive instructions from the plurality of users concerning completed and incomplete actions, responses and decision events;
using an automated system to alter the nature and number of completed and incomplete actions, responses and decision events which are to be commenced and completed depending upon the instructions received from one of the plurality of users concerning actions and decision events; and
using an automated system to alter the time and duration in which particular actions and decision events are to be commenced and completed depending upon the instructions received from one of the plurality of users concerning actions and decision events.

19. The method of claim 18, wherein instructions regarding actions, responses, and decision events can be received from a plurality of remote locations.

20. The method of claim 19, wherein the plurality of users comprise a plurality of government organizations.
